(19) United States
(12) Patent Application Publication
(10) Pub. No.: US 2004/0104221 A1
(43) Pub. Date: Jun. 3, 2004

(54) Sterlization and transportation system method by microwave technology of high temperature and pressure

(76) Inventors: Buhei Kono, Kyoto (JP); Kazuhito Kono, Kyoto (JP)

Correspondence Address: Buhei Kono, 801 313 Sashimonocho Ebisugawa agaru, Kawaramachi dori Nakagyo, Kyoto, 604-0903, JP

(21) Appl. No.: 10/307,042

(22) Filed: Nov. 28, 2002

(51) Int. Cl. H05B 6/78

(52) U.S. Cl. 219/700; 219/698

(57) ABSTRACT

This innovative technology is the method of sterlization, processing food and consecutive cooking method by microwave more than 100° C. temperature. Previously such technology existed by microwave is heating, cooking, drying. This innovative technology by microwave is sterlization process.

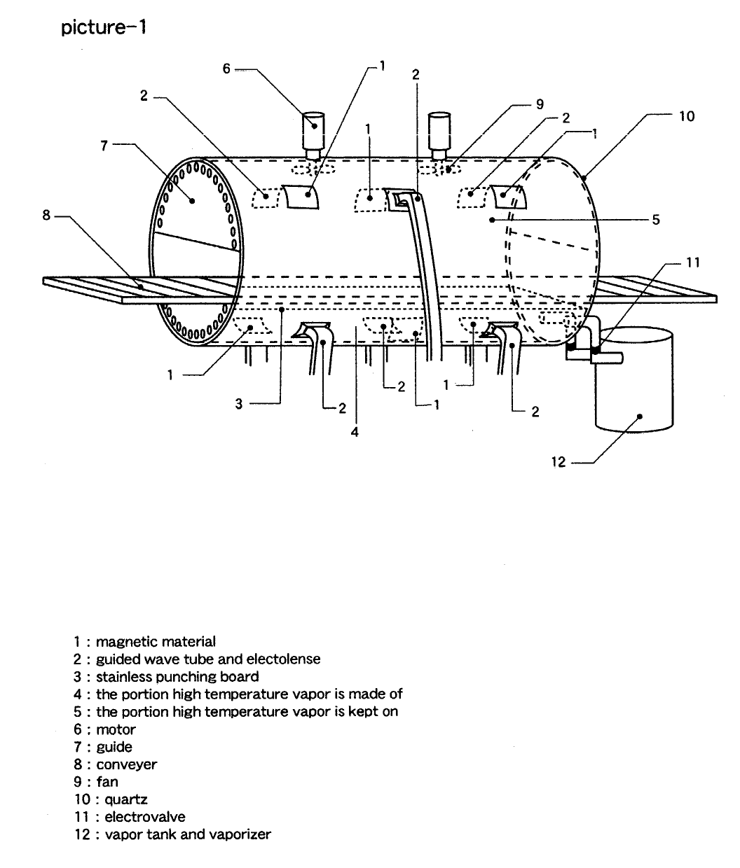

### BACKGROUND OF INVENTION

We offer the method of sterlization of food, processing, cooking, possible of temperature control depends on item, seaquential method which is short time, low energy cost. This is the processing method by magnetic substance material, zirconia, carbon graphite by using microwave irradiation high temperature control. As to food industry, food supply industry, The safety standard is required by the standard of HACCP. In vegetable, there are a lot of food poison fungus found. It is thought to be hard of transporting perfect sterlized status. For the cheap cost product like a vegetable, it is required for being processed a lot, consecutively and low cost. In ordinary pressure, normal temperatute looking is got by irradiation by microwave, by the method of the magnetic substance material and zirconia, carbon composite. The magnetic substance material nickel ferrite which can control microwave irradiation 2.45 GHz, 0.5 kw, 140° C., lithium ferrite can control about 200° C. Microwave irradiation with zyroconia and carbon composite is 2.45 GHz 0.5 kw, it controls temperature by heat and thermocoupling within 2-5 minute. It can get high temperature 100-1000° C. The boiling water poured irradiated by microwave continuously under normal pressure, temperature, vapor. It made belt conveyer work possible. In vegetable sterlization, each vegetable's sterlization temperature is decided 150-300° C. In this temperature zone within 3-7 seconds, caliform bacilli shows negative. General fungus show negative or less than 100. In cucumber, daily use M at temperature 200° C. within 4 second caliform bacilli shows negative, the daily sales tomato, the size M.S. at 200° C., the caliform bacilli and general fungus both show negative.

The potate peel the surface with 3.5 cm at 250° C. within 5 seconds caliform bacilli show negative. As to onion, we need to cut the peel, cut the of 3.5 cm, set 250° C. within 5 second, caliform bacilli show negative. As to onion, we need to cut the peel, cut the size of 3 to 5 cm, set 250° C. within 7 second, caliform bacilli and general fungus show negative. In vegetable, on the transportation of raw vegetable, we lower the temperature, for high temperature sterlization clean the organic goods in 0-5° C. pure water dry the vegetable with 0-5° C. sterlization condition, cut the moisture by dry air we can conduct sterlized vegetable. This transportation method uses reduced pressure vessel or reduced pressure package under 0.5 in low temperature, we can do perfect sterlized vegetable transportation. After freshness preserving term, after processing 10 days perfect state, The increase of fungus is not shown after vegetable is heated, it can prevent the quality of degragate, as the tomato, states of stopping maturity, transportation is possible. Asparagas and sweet corn are the vegetable of easy nature, but once stop maturity, transportation is possible. The pure water is got by R.O. purification facility. The clean dry air is got by compressor which removes the fungus by filter. we can control the cooking system by the controlling temperature. The greens and food pack are delivered by daily use after processing 7-12 hours which are hygiene conducting. The sterlization of packing, food processing, cooking processing sterlization of heat proof fungus is 130° C., in high temperature sterlization, perfectly sterlized condition. Under high temperature vapor, we can control 100 to 300° C. temperature we can set freely, in short time, fungus is attached vegetable green, food package, and sterlize the fungus which drop in the room. Under high temperature, high vapor, vegetables passed under belt conveyer within 3-5 seconds, effective processing is possible. Cereals, powder, spices are the food which includes a lot of food poisoning. Cereals with green, powder food, spices are imported from foriegn. The number fungus are many. Under normal pressure, high temperature vapor instant sterlization, after sterlization automatically high temperature, it doesn't need crystalization.

By the instant sterlization, It doesn't decay flavor of the food material. we can pesticide insect attack in cereal instantly. If we set the temperature, processing, depends on the grain of powder. We set 250° C. maximum 3 m height, rim on the surface conveyer. General fungus are less than 100.

The green, pickles, dried vegetable, fruit vegetable juice can, can processing food which are from vegetable, flavor vitamine mineral decay, and taste and neutrient decay under long time high temperature processing. The purpose of long time processing is sterlization. Before processing if foods are sterlized under high temperature vapor, it doesn't need long time processing. It can process under keeping composite of vegetable. The process functional food, in the vegetable herb, We abstract trace element, before its sterlization process will be done, when I do long time sterlization composite is easy to change. The low cost abstract is small. We can abstract protein, suger protein, flavor trace element, in vacuo, within 3-7 seconds, short sterlization 50-80° C. under normal pressure and high temperature vapor. The method of food processing, cooking processing, burning, steaming, frying are concurrently made by microwave with normal heating method of room temperature control. The domestic heating of food and partial heating of food become possible. It can thoroughly be heated and processed. The high temperature vapor, normal pressure are controlled by the material of microwave irradiation, magnetic substance material, zirconia, carbon graphite, thermocoupling. We can stabilize temperature, continously high temperature vapor in the facility. Under the high temperature vapor, cooking food, and processing food pass through in short time, cooking is possible later or initial microwave irradiation only after the food is passed through high temperature vapor, we can prove effectively before food cooking such as frying, boiling, burning, steaming, when microwave is irradiated, domestic of food become hot tempearature heating, we can stabilize cooking drying food processing. After heat vapor processing, we process by microwave, we can stabilize the shape and taste softly. In vacuum cooking, sterlization process, spice, below, 80° C. temperature, it becomes possible.

The other advantageous of this innovative sterlization process, is to sterlize bacillus anthracis which is attached in mail or envelope safely, easilily. Under 200° C. within 2-3 seconds, it is possible for bacillus anthracis to be sterlized perfectly. Under normal pressure, 200-300° C., high temperature, normal pressure, vapor, the envelops or mails which have Bacillus anthracis are passed through, bacillus anthracis is sterlized within 3-5 seconds. We irradiate microwave by pulse signal, it can achieve 200-300° C., high temperature, normal pressure, vapor, the envelope or mail which have bacillus anthracis are passed through. bacillus anthracis is sterlized within 3-5 seconds. We irradiate microwave by pulse signal, it can achieve 200-300° C. It can make high temperature vapor, envelopes are passed through, they can be sterlized. Before gathering mails, they pass through under tunnel of high temperature vapor by conveyer, bacillus anthracis can be sterlized.

### SUMMARY OF INVENTION

This is the invention of processing, cooking food system, and sterlization system of grain, powder food, fruit vegetable, by the use of normal pressure high temperature vapor system and microwave irradiation system concurrently. The structure of drum, rectangular, are constructed by quartz partially or wholly. We irradiate microwave from outside of quartz by guided wave tube. We irradiate microwave and control electrowave by electrowave lense, and absorb in magnetic substance material, and temperature control by setting zirconia, carbon graphite by thermocoupling. We can get instantly 100° C.-1000° C. more in short time by this method. The temperature of heating material keep stable in high temperature. When we irradiate microwave by magnetic substance material, the temperature begins to raize up, maximum temperature is 1000° C. We can control temperature by thermocoupling. We can make outer structure for outside of cylindrical or rectangular to get high temperature vapor. We keep high temperature vapor pressure selecting, setting temperature 100-1000° C. by microwave irradiation 's heating material in the cylinder and rectangular. we select the temperature 100-1000° C. and set for sterlization food processing and cooling. We set the temperature 100-300° C., control normal pressure high temperature vapor, we flow food and vegetable by tunnelling method, it makes consecutive sterlization, food processing possible. If we vaporize water by microwave irradiation, ionized material, and the contents, the time of achieving boiling point, vaporized speed is deviated. If we contain ionized vapor, we efficiently in short time achieve high temperature and boiling point. If we irradiate microwave with 2.45 GHz, 0.5 kw to 100 ppm ionized Na liquid, 1,000 ppm ionized liquid. The ionized Na liquid 1,000 ppm is half time as ionized 100 ppm liquid. If we irradiate by microwave to the liquid which include activitied carbon, carbon graphite, we can achieve boiling point in 10 to 20 seconds. We irradiate microwave to vapor of ion, we can get vapor more than 100° C. This is the method of effective heating method of water and organic water. The single microwave irradiation consecutively in pulse, it has sterlization effect. The sterlization of food processing and control burning, boiling, frying, steaming, we can proceed this process in short time consecutively. The irradiation of microwave is from the domestic material, heat processing. The irradiation of microwave is from more than 100° C., heating from outside by heat conduction, we use microwave irradiation and high temperature vapor pressure can process in short time, we can sterlize the temperature, reform cooking, heating temperature, and can reform burning of mistaken cooked. We irradiate microwave to magnetic substance material by electrowave lense from facility, we can prevent from leaking electrowave minimally. We can prevent less than 20 micron by stainless, alminium metal net. If we irradiate microwave continuously, it leads to partially deviated irradiation. we can reform it domestic little fan in it. We can sterlize the process the food under normal pressure, high temperature vapor by microwave irradiation.

The normal pressure, high temperature, vapor sterlization of microwave irradiation (temperature 150° C.-300° C.) can make bacillus anthracis sterlized within 2-5 seconds. If we make this structure tunnel, we can sterlize them consecutively. In the process of large amount sterlization like mails, before gathering, we sterlize them, the quality of safety is better. We irradiate microwave by pulse under normal pressure temperatuew 250° C. vapor, tunnel, we pass through mails with 5 seconds, we can sterlize the bacillus anthracis.

### DESCRIPTION OF DRAWING

Picture-1-total

1; magnetic substance material

2; guided wave tube, electrowave lense

3; stainless punching board

4; The portion high temperature vapor is made of.

5; The portion high temperature vapor is kept on.

6;motor

7;guide

8;conveyer

9;fan

10;quartz

11;electrovalve

12;vapor tank and vaporizer

From the vapor tank, the vapor gas into the area 4, heated by microwave irradiation to magnetic substance material is high temperature. From the hole of punching board vapor goes up, enters 10. The microwave irradiation and magnetic substance material set is 5 which keeps high temperature. In that space, belt conveyer carry food and vegetable sterlization, processing, cooking are possible.

DISCRIPTION OF INVENTION

The processing system of high temperature and high pressure vapor system and sterlization system and processing and cooking system of powdered food and fruit and vegetable that is taken advantageous of microwave irradiation. The quartz structure 10 which is made cylindrical and rectangular shape, we introduce microwave by guided wave 2 from the source of microwave outside the quartz glass 10. We made the structure of cylindrical and rectangular structure, in side of that, we irradiate microwave. I set up electrowave lense 2 focusing and set up the zirconia, carbon material 1 and magnet material and irradiate microwave toward the inside of rectangular and cylindrical structure, zirconia and carbon material got heated, in short temperature, it got 100° C. more than 1000° C. The temperature of heating is depended upon curie point and crystal structure and wavelength of irradiation. I can control the optimal temperature by curie point of magnetic material by the effect of specific heat. If the magnetic is strong, the specific heat is high. The magnetic material 1 is kept substantial high temperature. When I irradiate zirconia and carbon material continuously, the temperature raised up maximum more than 1000° C. I can control the temperature by thermocouple. To get high temperaute and high pressure from the outside of cylinder and rectangular I tranfer vapor 12. I irradiate microwave the heating portion of zirconia carbon material and magnetic material 1, from high temperature 100° C. to 1000° C. set up the temperature control the temperature by curie point of magnetic material 1 and its specific heat effect, sustain high temperaure and high vapor status. I set up the optimal temperaure of sterlization and food processing and cooking inside the heating position, I transfer the vapor 12 and vapor got more than 100° C. high temperature. We accumulate controlled normal pressuue, high temperature vapor setting temperature 100-300° C. and blow continuously. After getting normal pressure high temperature vapor, we transfer food and vegetable continuously under the tunnel structure, I can continuously sterlize and cook and process the food in large amount. When I irradiate microwave water and vaporize, the time of boiling and vaporization speed depends on the amount of ion including in water. When I irradiate microwave to get temperature of boiling point, containing ionized material in water is effective method.

The more ionized sodium in water, the faster we can get boiling temperature. When I irradiate the water which contains sodium ion 100 ppm and 1000 ppm by microwave 2.45 GHZ and 0.5 kw. The time of achieving boiling point shortens ½. When I irradiate water which contains activitied carbon and carbon composite, we can get boiling point in 10 and 20 seconds. We irradiate water which contains ionized material in water, we can get water more than 100° C. under normal temperature. This is the method of microwave heating of water and organic liquid. When I irradiate microwave pulse continuously, The sterlization effect exists. The effect of 100° C. more than high pressure and high temperature vapor makes food sterlized processed, burnt, fried, boiled and continuously cooked. The microwave irradiation heat from domestic of material, under normal pressure more than 100° C., high temperature vapor heat from outside. The concurrent use of microwave irradiation and high temperature vapor makes processing food short and reform the shortage of heating tamperature which causes sterlization error and burnt by overheating. When we irradiate microwave by electrowave lense 2 and focus irradiation to magnetic material, leak of electrowave is limited minimum and controlled, to prevent electrowave leaking, we can use less than 20 micron stainless and aluminium metal net. When I irradiate microwave continuously, deviated irradiation occurs, we use the fan, it can be recovered. This is the method of microwave irradiation and normal pressure, high temperatute vapor which is made by microwave irradiation that makes sterlization, food processing and food cooking possible.

The fungus is attached in grains and powders of food and poisonous fungus is often attached in imported spice. Under 200-300° C. high temperature, a lot of fungus including caliform bacili is sterlized in 3 and 5 seconds. Under normal pressure high temperature boiling, foods are transfered continuously and sterlized. The grains and powders, because of space between powders, sterlization is often hard. Under high temperature, boiling sterlization, things are wholly stably sterlized. The component change after sterlization is restricted low. This is the method of sterlization process of powder and grain under normal pressure and high temperature. The vegetable and fruit, cucumber, tomato asparagus, sweet corn, welsh, radish and fruit have a lot of problem of fungus and fresh in transportation system. About these vegetable and fruit, under 200-300° C., 3-7 seconds, high temperature vapor, they are transfered, general fungus and poisonous fungus can be sterlized. After sterlization, 0-10° C. pure chiller water washes the organic. the temperature of vegetable is lowered 0-5° C., chiller clean air wash the water of skin, low pressure package, after low temperature transportation, one stable time, non fungus status is kept 7-10 minutes, freshness is kept and vegetables are transported non fungus status. The quality of goods is kept during transportation. The diminishment of vitamine C which is needed for the quality of vegetable is reformed greatly. The asparagus and sweet corn is inclined to change their suger and change by time is rigorous and sustainablility of freshness is hard, under processing, high temperature vapor, they can sustain the suger of harvest and taste is kept during transportation. The fruit is often polluted by mildew in summer and rainy season. After processing fruit under high temperature vapor during 4-7 seconds after that 0-5° C. pure water clean the organic of vegetable, clean dry air eliminate the water of peer, under low temperature transportation, long time decay can be prevented.

The root vegetable and sweet potato and potato, vegetable processing goods are eliminated peel and washed, in raw status packed and processed and sales. These vegetable include a lot of gemeral fungus and caliform bacili The speed of aggravation is fast, the problem often exists in vegetable processing factory. After peeling the skin of root vegetable, sterlized under high temperature vapor, transported 0-5° C. chiller water cleaning, afetr cooled down, packed 0-5° C. low temperature transportation non fungus status is possible.

The vegetable and packed food like Japanese bento is dealt with after cooking, After dealing, 2-5 sconds high temperature vaporize 200-300° C. The fungus attached in surface is sterlized perfectly. The pollution of pack like a bento is prevented. The damage of pack is less and safe administration is possible. The processed vegetable is possible for pickle processing, vegetable processing, dried vegetable, fruit juice processing vegetable can processing, protein, vitamin mineral, flavor isn't damaged. The microwave processing of food is well known to be heated from the central of food. The animal meat with bone, chicken and fat meat and fish meat is heated from central and fat. After that, controlled temperature normal pressure and high temperature, passed through one substantial time, surface is heated. The consecutive cooking of burning, boiling got possible in short time. The consecutive cooking of hamburger, stake, roast beaf chicken fried chicken which use fat in cooking got possible. The bean and tea are processed under 120° C.-300° C. normal pressure, high temperature vapor 5-6 minutes boiling, after that, high temperature drying by microwave irradiation, solid of food is not condensed status but soft status. We don't damage flavor, perfect sterlization processing is possible. In vacuum cooking, after dealing with 130° C.-200° C. high temperature boiling, after sterlization, cooking liquid is put into, sterlization process of food can be omitted, only cooking heating in low temperature is possible.

In the leafy vegetable, root vegetable, outside of cabbage, peel of radish, peel of potato and portion of not eating place is eliminated, sterlized 150-300° C. normal pressure, high temperature, vapor instantly sterlized during 3-7 seconds, a lot of vegetable can be transported in sterlized status. we cut vegetable only portion of eating and directly consumed, under normal pressure, high temperature vapor, under high temperature 150° C.-300° C. dealt with 3-7 seconds, poisonous fungus and general fungus got negative. After sterlization, chiller water clean the organic of vegetable in low temperature, lower the temperature of food, eleiminate water by non fungus dried air 0-10° C. low temperature under reduced pressure transported, freshnes of vegetable is kept 10 days after harvest. The occurence of raw waste of vegetable in urban area is reduced and transportation cost of vegetable is reformed greatly.

In the picture 1, The structure of vaporizer which is high temperature vapor. The cylinder material is quartz tube material. The structural material is made to be forbear from high temperature vapor from microwave irradiation.

The total structure on the portion which microwave irradiate is made of quartz 10. It has the effect of forbearing heat, transparency of microwave, identification from outer. From outer vaporizer 12, we accumulate vapor from pressure tank 12, insert vapor below the picture-1-4. The picture-1-4,1-5, are divided space. We irradiate microwave magnetic substance material, microwave guided wave tube 2 set 150-300° C., the temperature, irradiation kept high temperature. The magnetic substance material 2 is set higher temperature than space 5. We irradiate microwave by the magnetic substance material 2 and set the sterlization adoptable temperature space 4, space 5 is shutted by the standing board at space 5, steam raises up. The stable temperature and focusing electrowave thoroughly we set small fan. The belt conveyer is set for the processing time and stablize the position, the normal pressure and high temperature vapor cover all and sterlize, also cooking processing according to microwave irradiation portion's magnetic substance material's effect.

1. The processing system of high temperature and high pressure vapor system and sterlization system and processing and cooking system of powdered food and fruit and vegetable being taken advantageous of microwave irradiation, introducing microwave by guided wave from source of microwave outside the qurtz glass, making structure of cylindrical and rectangular, electrolense focusing, setting zirconia, carbon material, magnetic material, irradiating that, optimal temperature by curie point of magnetic matrial of specific heat being set, magnet being strong, specific heat being high, being kept high temperature, controlling temperature by thermocouple tranfering vapor from outside the quartz glass by vaporizer, heating by microwave irradiation, vapor temperature being high in normal pressure sterlizing food and vegetable, sodium ion being included in vapor, temperature being more than normal temperature, more effective in sterlization.

2. The possibility by high temperature normal presssure of vapor of fungus and caliform bacili in short seconds, close sterlization of grain and sterlization of fruit and vegetable, cucumber, tomato, asparagus, sweet corn for transportation system, by keeping quality of vegetable by high temperature normal pressure vaporizer, general fungus and poisonous fungus showing negative by this method, leafy vegetable, root vegetable, outside the cabbage, peel of radish, peel of potato and portion of non eating place being eliminated sterlized under normal pressure, high temperature, chiller water cleaning the organic of vegetable, eleminating water after dried after high temperature normal pressure vaporizer, freshness of vegetable being kept 10 days after harvest, directly being consumed, raw waste of vegetable being reduced by this vegetable cleaning method, consecutive soft cooking of hamburger, chicken and meat by high temperature normal pressure vapor by sterlization being possible.
